(19) United States
(12) Patent Application Publication
(10) Pub. No.: US 2003/0120672 A1
(43) Pub. Date: Jun. 26, 2003

(54) Method and mechanism for managing content objects over a network

(75) Inventor: Earl B. Bingham, Los Altos, CA (US)

Correspondence Address: Silicon Valley Patent Agency, 7394 Wildflower Way, Cupertino, CA, 95014, US

(73) Assignee: XMLCITIES, INC., Milpitas, CA

(21) Appl. No.: 10/325,086

(22) Filed: Dec. 20, 2002

Related U.S. Application Data
(60) Provisional application No. 60/343,114, filed on Dec. 21, 2001.
(60) Provisional application No. 60/343,116, filed on Dec. 21, 2001.
(60) Provisional application No. 60/347,728, filed on Jan. 11, 2002.

(51) Int. Cl. G06F 7/00

(52) U.S. Cl. 707/100

(57) ABSTRACT

Techniques for managing content objects across a distributed network are described. According to one aspect of the techniques, a mechanism is provided to ensure that information in a server is always updated by encapsulating the information in an object that may be managed in another machine. The object may include a unidirectional link to a corresponding one in another machine, thus any change to one of the objects in two different network nodes will be timely synchronized.

### CROSS-REFERENCE TO RELATED APPLICATION

This application claims the benefits of U.S. provisional application No.: 60/343,114, entitled “Dynamic Link Management of a Content Management System” and filed on Dec. 21, 2001, U.S. provisional application No.: 60/343,116, entitled “Mechanism and Apparatus for Management of User Profile Information for Security and Content Management” and filed on Dec. 21, 2001, and U.S. provisional application No.: 60/347,728, entitled “System and Method of Editing Web Content over the Internet” and filed on Jan. 11, 2002, each of which is hereby incorporated by reference for all purposes.

### BACKGROUND OF THE INVENTION

1. Field of the Invention

The present invention generally relates to the area of exchanging information between computers over a data network, particularly relates to method and mechanism for managing content objects in a distributed system including a plurality of nodes, each representing a computing device.

2. Description of the Related Art

The Internet is a rapidly growing communication network of interconnected computers around the world. Together, these millions of connected computers form a vast repository of hyperlinked information that is readily accessible by any of the connected computers from anywhere and anytime. With millions of web pages being created and added to this vast repository each day or year, there is a tremendous need to keep the information updated by synchronizing with its sources.

Generally, the accessible information is distributed among a number of computing devices and each of the computing devices is managed separately. FIG. 1 illustrates a data network model 100 modeling many computers interconnected around the world. Each of the nodes represents a computing device to which other corresponding nodes (i.e. other computing devices) are connected directly or indirectly for sharing information or communications. One of the examples for the model 100 is the Internet.

To provide efficient accessibility, some of the nodes distributed around may host related information for other nodes to access, perhaps, to avoid accesses from everywhere to only one node. For example, the node 102 is a hosting node including various related information, but some of the information are managed in the nodes 104, 106 and 108. To ensure other nodes (except for the nodes 104, 106 and 108) to access the hosting node 102 for the latest information, changes or updates to any of the information managed respectively in the nodes 104, 106 and 108 must be immediately reflected in the hosting node 102. However, complex synchronization issues can be created with the cascading effects in the hosting node when more than one node tries to update one message at the same time. There is a need for conducting or synchronizing updates to the message(s) among multiple nodes.

In addition, when one of the nodes (e.g., 104, 106 and 108) is accessed by a user to make a change to a message over a public network, the user must be confirmed to be what he/she claims to be to avoid unauthorized changes to a message. There is another need for ensuring that only authorized user can access a node to change/update a message.

To facilitate the management of the message and their use to other nodes, there is still another need for solutions of how to manage the messages across a distributed network.

### SUMMARY OF THE INVENTION

This section as well as the abstract is for the purpose of summarizing some aspects of the present invention and to briefly introduce some features or preferred embodiments. Simplifications or omissions may be made to avoid obscuring the purpose of the section or the abstract. Such simplifications or omissions are not intended to limit the scope of the present invention.

The present invention pertains to methods and systems for managing content objects across a distributed network. According to one aspect of the present invention, a message or messages, together with at least one style sheet, are encapsulated in a content object or simply an object. One of the advantages of using content objects is the underlying mechanism provided to facilitate a proper presentation of the message or content in a content object in a given application, for example, to form HTML files to be displayed in Microsoft Internet Explorer, to form WML files to be displayed in a WAP-compliant micro-browser.

According to another aspect of the present invention, the content objects are hosted in a hosting node and respectively managed in nodes designed to support the hosting node. To ensure that a hosting node is timely notified of any change to the content objects, each of the content objects is instantiated by a software class that is included in a process that is executed in one node. As a result, any change to one of the content objects triggers an event to publish the changed content object to the hosting node and the hosting node is thus always synchronized with its nodes providing the content sources.

According to still another aspect of the present invention, an authentication procedure is used to ensure that only authenticated user can change an object in a node that supports the hosting node or in the hosting node. In generally, an object in one node includes a unidirectional link to a corresponding object in another node, thus any change to either one of the objects will result in a corresponding change to another object, thus having realized synchronization between the two objects.

According to still another aspect of the present invention, a change may be made through an editing tool to a final presentation (e.g., an HTML page) from an object (via an XML file and a style sheet therein) or the object itself. In any case, with the mechanism provided in the present invention, any change can be reflected and synchronized, as a result, latest information from a hosting node can be provided.

One of the objects in the present invention is to provide a generic solution to manage content objects in a distributed network.

Objects and advantage together with the foregoing are attained in the exercise of the invention in the following description and resulting in the embodiments illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 illustrates a data network model modeling many computers interconnected around the world;

FIG. 2 shows a basic system configuration in which the present invention may be practiced;

FIG. 3 shows a protocol binding that is used in one embodiment of the present invention and is referred to be as an HTTP binding for messaging between two nodes;

FIG. 4A displayed a scenario in which node A has a set of content objects;

FIG. 4B shows a process or flowchart of updating content objects from a node that is configured to manage the content objects;

FIG. 5A shows a communication structure layer used to communicate changes to content objects between applications or nodes over the Internet (e.g., over HTTP);

FIG. 5B shows a message envelop including a SOAP body and a SOAP header;

FIG. 6 shows a process or flowchart of updating content objects from a node over a network;

FIG. 7A shows a diagram of objects, files and editors involved in editing one or more of the objects;

FIG. 7B shows a detailed configuration in which the present invention may be practiced; and

FIG. 8 shows a process or flowchart of editing content objects over a network.

### DETAILED DESCRIPTION OF PREFERRED EMBODIMENTS

The present invention pertains to techniques for managing content objects across a distributed network. According to one aspect of the techniques, a mechanism is provided to ensure that information in a server is always updated by encapsulating the information in an object that may be managed in another machine. The object may include a unidirectional link to a corresponding one in another machine, thus any change to one of the objects in two different network nodes will be timely synchronized.

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

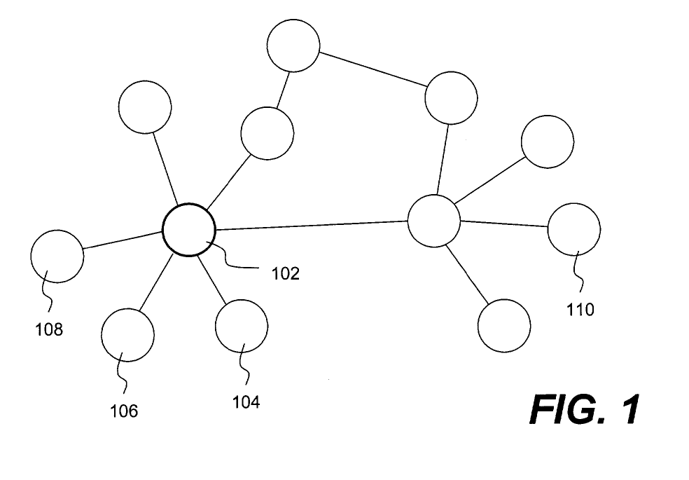

Embodiments of the present invention are discussed herein with reference to FIGS. 1-8, in which like numerals refer to like parts throughout the several views. However, those skilled in the art will readily appreciate that the detailed description given herein with respect to these figures is for explanatory purposes as the invention extends beyond these limited embodiments.

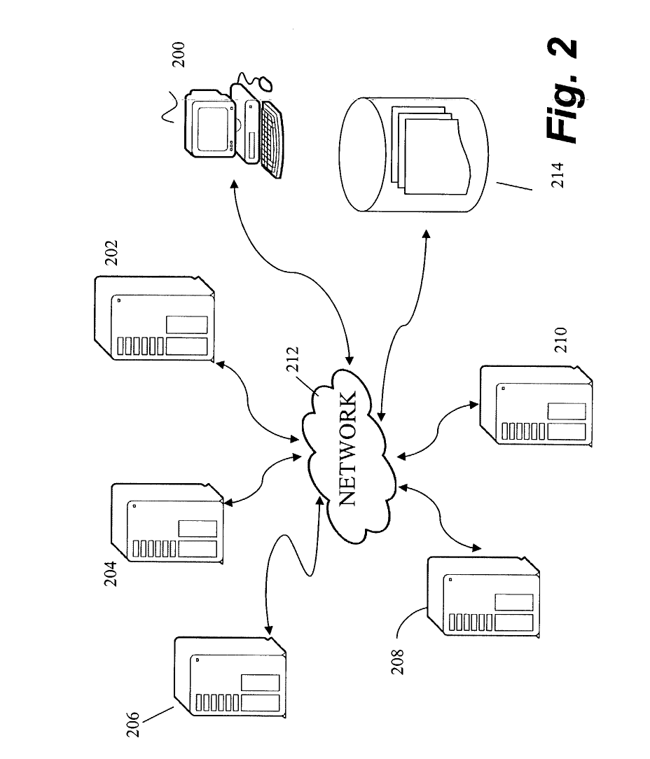

Referring now to FIG. 2, there shows a basic system configuration in which the present invention may be practiced. The representative computer system shown in FIG. 2 includes a workstation or personal computer (PC) 200 coupled to other devices through a data communication network 212. The personal computer 200 represents many types of terminal devices that may be used by users to inquire specific information from a computing device or machine (e.g., an application server) 202.

The server 202 hosts a large number of content objects, each providing certain type of information that may be of interest to users and accessible over the network 212. As used herein, a user may mean a human user, a software agent, a group of users, a device and/or application. Beside a human user who needs to access information, a software application or agent sometimes needs to access the information in order to proceed. Accordingly, unless specifically stated, the “user” as used herein does not necessarily pertain to a human being. According to one embodiment, each content object includes a content portion (i.e. an object) together with a presentation portion (i.e. an object). The presentation portion facilitates the content portion to be presented in a desired form in a given application. For example, the content portion is an XML file and the presentation portion is an XSL file. XML (Extensible Markup Language) is a flexible way to create common information formats, unlike HTML, the markup symbols are unlimited and self-defining, thus commonly believed to be a simpler and easier-to-use subset of the Standard Generalized Markup Language, the standard for how to create a document structure. XSL or extensible style sheets are used to transfer the (XML) documents into desired presentations. The advantages of encapsulating contents in an object or a content object can be further appreciated below.

Examples of the content objects, namely content portions, may include, not be limited to, marked-up languages files, audio, video, and images. At least some of these content objects are respectively provided by or managed in the computing devices 204, 206, 208, and 210. In other words, whenever there is an update at one of the computing devices 204, 206, 208, and 210 to one of the content objects, the server 202 receives the update timely and as such the content objects in the server 202 stays updated and users are expected to receive the latest and updated information from the server 202.

To facilitate the description of the present invention, the following description will be based on the assumption that the content portion and the presentation portion in an object content is one or more XML and XLS files, respectively and each of machines or devices coupled to a network (e.g., the Internet or a local area network) is considered as a node in the network.

According to one aspect of the present invention, a mechanism is provided to manage these content objects in a manner that allows for indexing, searching, updating, retrieval and others. According to one embodiment, this mechanism is configured to have a process for a computer network to have software classes that instantiate each content object. These classes are then executable by a processor on a data network. The process or another process monitors each content object for when an update is made to the content object. The monitor then triggers an event on the network that publishes this update to the other nodes of the new content object instance. In general, the content objects have potential links to other content objects that are unidirectional in nature. The mechanism for handling updates on the network provides a full round-trip of updating the content objects in real-time.

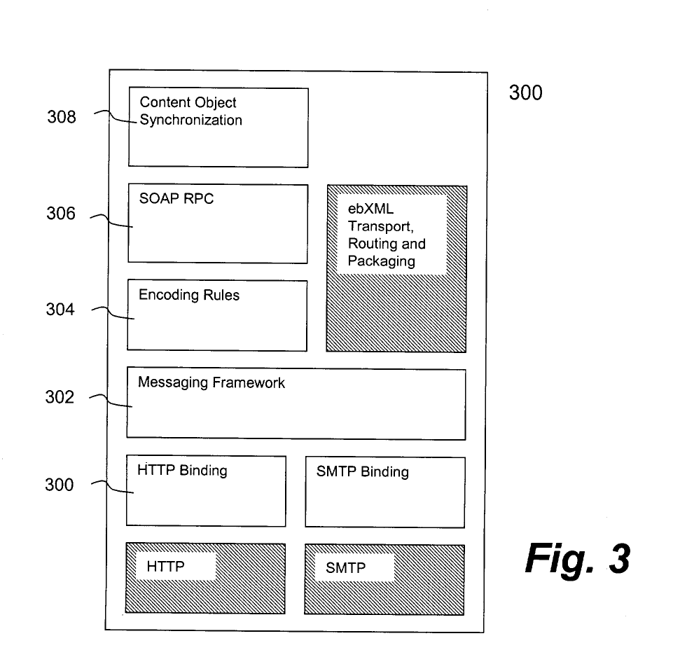

FIG. 3 shows a protocol binding 300 that can be used for the mechanism and is referred to be as HTTP Binding used in the messaging between two nodes. The protocol binding 300 includes other application protocols with a message (including an update to a content object) residing on top of SOAP 306 (Simple Object Access Protocol), thus allowing for simple sending of large files and other complex forms of data.

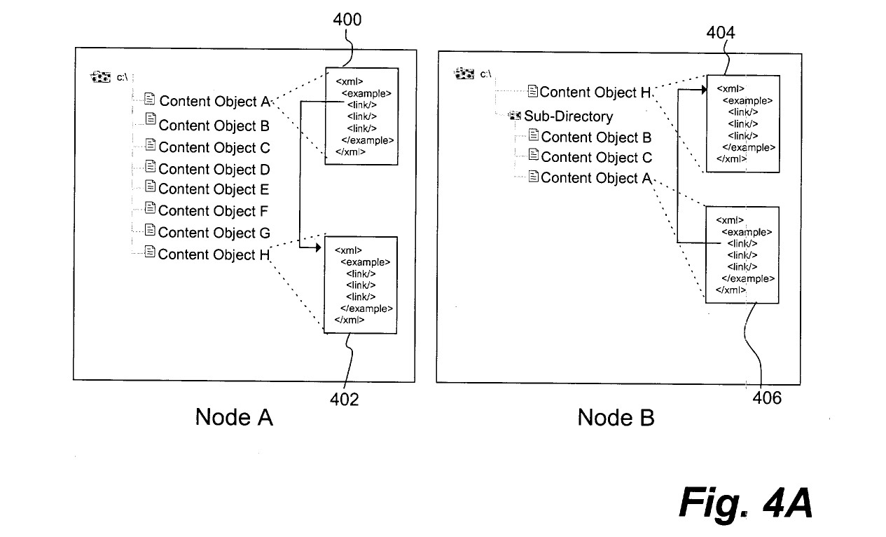

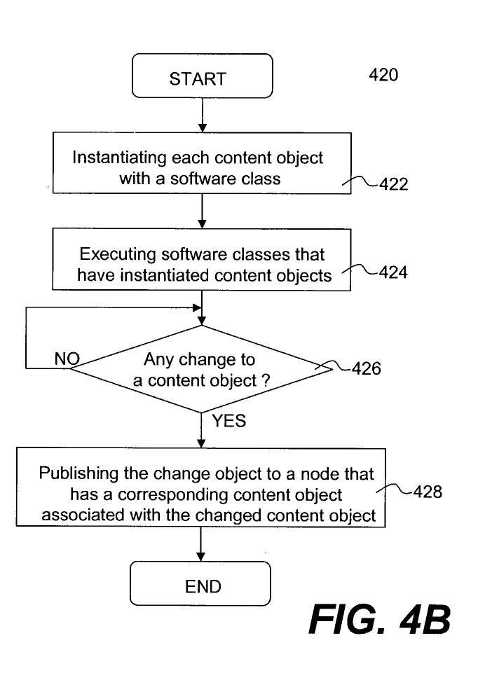

FIG. 4A shows a scenario in which node A has a set of content objects. In particular, there are two objects 400 and 402 that are synchronized and shared on Node B, corresponding to content objects 404 and 406. The relative links to other content objects are relative to node A. The same instance of the content objects on Node B has a different link representation relative to the organization of content objects on that system. The content objects represent one or more specific files, contents, or APIs to another application that will provide specific information when called upon. In addition, each content object has an associated meta-synchronization object (MSO) bonded together to manage a collection of attributes associated with each content object.

According to one embodiment, an HTML file on Node A has a link to another HTML file in the same directory. The link may be expressed as: <a href=“pressRelease.html”>. Then on Node B the same HTML file resides, but the corresponding link is associated with the same HTML file, but the file is located in another directory, so the link is: <a href=“../pressReleases/pressRelease.html”>

This facilitates the ability to have a set of content objects that can be arranged and organized in a very different manner than what is represented on another system. Each node contains meta information about the content objects so that management of these objects can be achieved efficiently.

According to one embodiment, the Meta information includes:

Versioning—the version of the object and log each change that is made after first initialization and setup.

Change log—changes made to the content object besides normal check-in and checkout process.

Dynamic or static content object—if the object is continuously changing in a real-time basis, then the object is managed differently and only specific meta-information is stored on that object. For example if the content object is a stock ticker, then potentially only the beginning and end of day values may be logged.

FIG. 4B shows a process or flowchart 400 of updating content objects from a node that is configured to manage the content objects. The process 400 may be appreciated in view of FIG. 2 and FIG. 4A in which one node hosts content objects to be accessible by others while another node is configured to manage the content objects.

In operation, at 422, each of the content objects is instantiated by a software class. For example, one machine is configured to manage k content objects corresponding to k content objects of N total content objects in a hosting node. Thus each of k software classes (e.g., in C++) may be defined to instantiate one of the k content objects. These classes are included in an executable process that is executed in a machine at 424, preferably in the background. The executable process or another executable process then monitors if any of the k content objects is changed or modified at 426. If there is no any change to any of the k content objects, the process 400 remains at 426 till any change is detected.

At 428, when a change to one of the k content objects is detected, the process goes to 428 in which the changed object is published to the hosting node, resulting in an update to a corresponding object in the hosting node. In practice, the process 400 loops between 422 and 428 to ensure that a hosting node is always and timely updated.

One of the features in the present invention is to ensure that the communication between a hosting node and a local node (e.g., one of the nodes 202, 204, 206, and 208) can be carried over the Internet that uses a common communication protocol such as HTTP. Many communications between two nodes uses Remote Procedure Calls (RPC) between objects like DCOM and CORBA, but HTTP is not designed for this and further RPC represents compatibility and security problems; firewalls and proxy servers will normally block this kind of traffic.

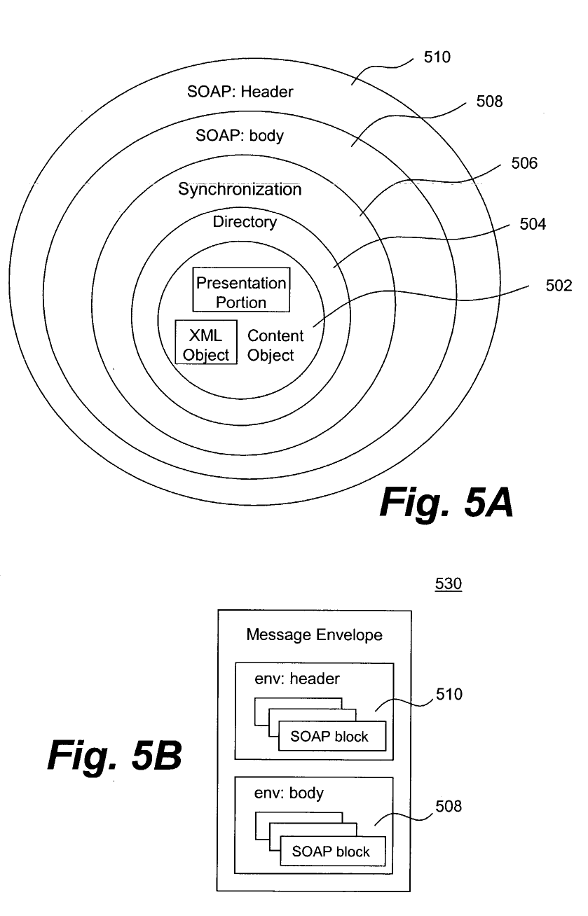

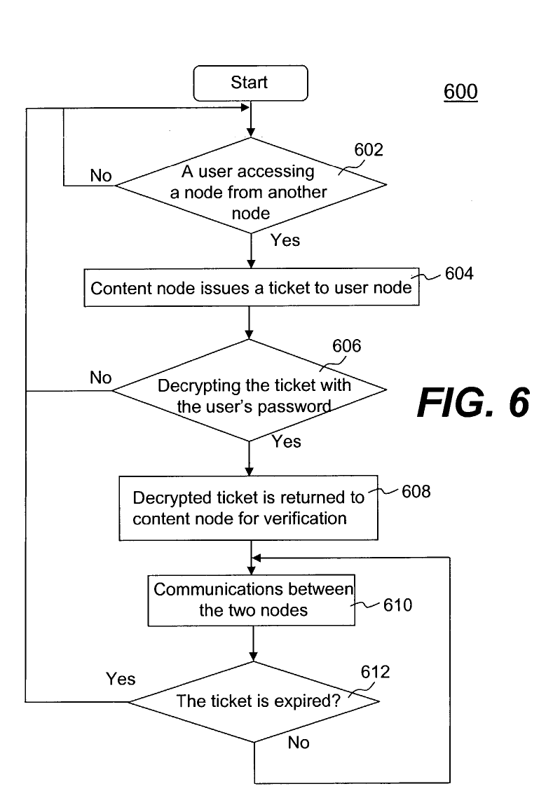

FIG. 5A shows a communication structure 500 used in one embodiment to communicate changes to content objects between applications or nodes over the Internet (e.g., over HTTP). In the center of the communication structure layer 500 is a content object 502 that includes a content portion and a presentation portion. Depending on implementation, the content object 502 can be a suite of objects or potions that include, in addition to a content object and a presentation object, a transformation object used to do specific operations on other objects before it is sent and received by other calling applications, a file object associated with a specific file (e.g., an image, or an HTML file) and an API object with specific applications that provide a specific query either statically or dynamically generated. Further an API object can be used to provide specific information that is needed for calling applications that request the API object.

Surrounding the content object 502 is the directory layer 504 and a synchronization layer 506, ensuring the persistence and synchronization of the content object 502 across a network. The outer layers are a SOAP body 508 and a SOAP header 510 and further shown in FIG. 5B, where SOAP stands for Simple Object Access Protocol that is an XML/HTTP-based protocol provided for accessing services, objects and servers in a platform-independent manner.

To ensure that only authorized user can update content objects residing in one or more machines across a network and subsequently facilitate the publication of changed content objects to a right node (e.g., a hosting node), an authentication procedure is used. In one aspect, the authentication procedure ensures a user trying to update a content object from a remote computing machine is what he/she claims to be, thus allowing two nodes (i.e., two machines) to communicate over a public network while preventing eavsdropping or replay attacks. In another aspect, the authentication procedure also provides for data stream integrity (detection of modification) and secrecy (preventing unauthorized reading) using cryptography systems such as DES.

According to one embodiment, a technique pertaining to the authentication procedure is Kerberos, a type of network authentication protocol. It is designed to provide strong authentication for client/server applications by using secret-key cryptography. Kerberos is available in many commercial products.

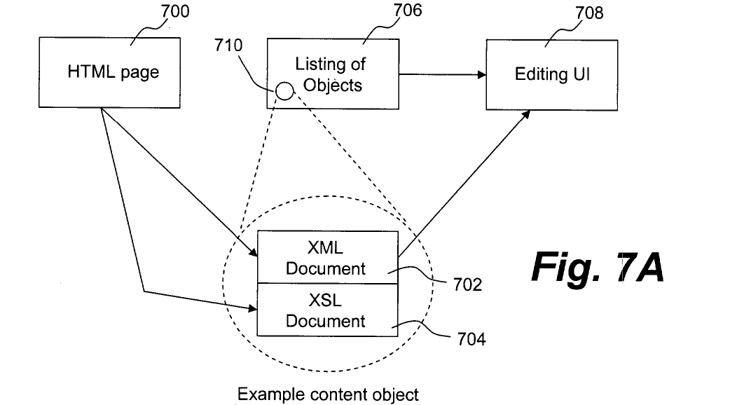

FIG. 6 shows a process or flowchart 600 of updating content objects from a node over a network. It is assumed that a machine or a node that is loaded with content objects subject to changes or updates is a content node, and another machine or node from which a user intends to access the content node to change or update the content objects is a user node. Both the content node and the user node are coupled to a public network.

At 602, the process 600 awaits a user to access the content node. Upon receiving a request from a user node, the content node issues a ticket to the user node at 604. In general, the request includes information about who the user claims to be. Accordingly, the ticket is generated with respect to the information provided. The ticket is time sensitive and encrypted with a predetermined encryption scheme. Depending on implementation, the ticket may be valid from minutes to hours to days.

Upon receiving the ticket from the content node, the user node loaded with an application tries to decrypt the encrypted ticket using with certain user confidential information (e.g., a password or phrase). If, for whatever reasons, the recipient of the ticket is not the user, the encrypted ticket may not be decrypted, resulting in a failure of the original request, the process 600 goes back to 602 to await another request. One the other hand, if the encrypted ticket has been successfully decrypted at 606, the process 600 goes to 608. The decrypted ticket is then returned to the content node for verification. It is assumed that both nodes now recognize each other, or the user has been authenticated, communications between the two nodes are now permitted at 610. As described above, the communications between the two nodes are in secrecy, in other words, any data exchanged between the two nodes are encrypted such that changes to one or more content objects in the content node are intended by the authenticated user.

For security reasons, the validity of ticket is constantly examined at 612. A ticket has been issued and assumed valid only for a certain period of time, during which the communications between the two nodes can continue. Beyond that time period, the ticket becomes invalid. As soon as the ticket becomes invalid, no further communications between the two nodes are permitted and the process 600 goes back to 602 to wait for another request from a user.

According to one aspect of the present invention, a framework for managing a collection of content objects over a network, particularly in a peer-to-peer network is provided. As described above, between two nodes in a peer-to-peer network that shares specific content objects, the protocol that manages the sharing includes authentication and authorization of communication between the two nodes (e.g., two applications running respectively in the two nodes). Once the authentication is established, messages between the nodes can be communicated. The communication between the two nodes is closed when either one of the applications is done or after a period of time.

In a case, two users desire to make changes to two content objects residing in two nodes, respectively, while these two content objects correspond to each other. According to another aspect of the present invention, the synchronization of content objects takes place to ensure that both sides are synchronized in terms of the content object with respect to user profile information. In one embodiment, it is configured to allow the original creator of the content object to be the final arbitrator on the synchronization process, ensuring that content object is synchronized appropriately between the various nodes connecting to the network. Based upon a pre-defined set of attributes, the synchronization could take place in different mechanisms.

In another case in which a node has a dynamic content object that is being updated continuously. If every time the content object changes, the update is published to the corresponding node or nodes on the network, tremendous traffic may be caused to the network. In this case the content object is considered as or includes an API object that has different attributes for synchronization associated with it. Only when the other nodes have there shared instance of this content object called upon do they then synchronize the information associated with this object. Essentially, the organization of the content objects that are shared on a network can be arranged differently on one node compared to how they are arranged on another node. This facilitates the ability to have personalized information supported locally to each node on the network.

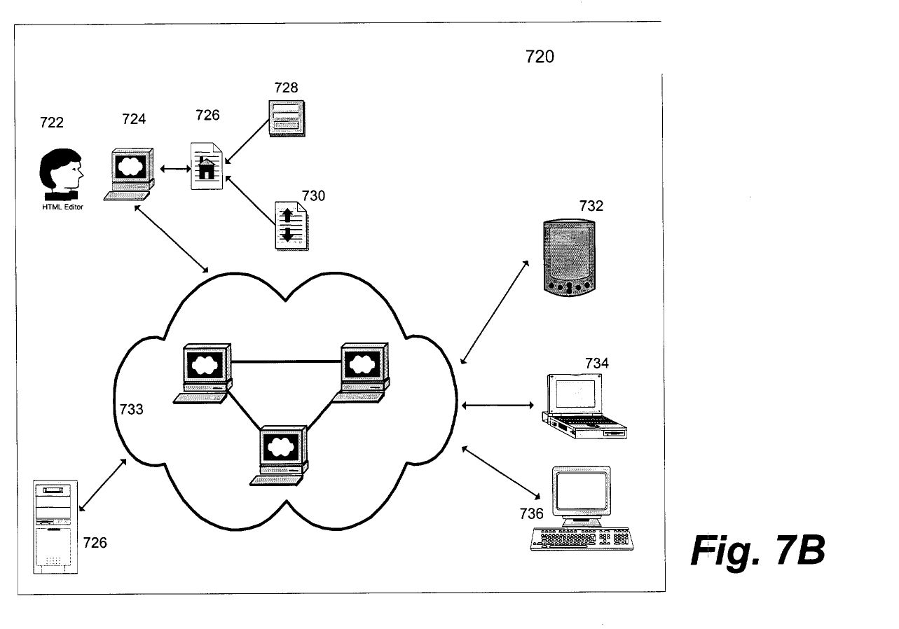

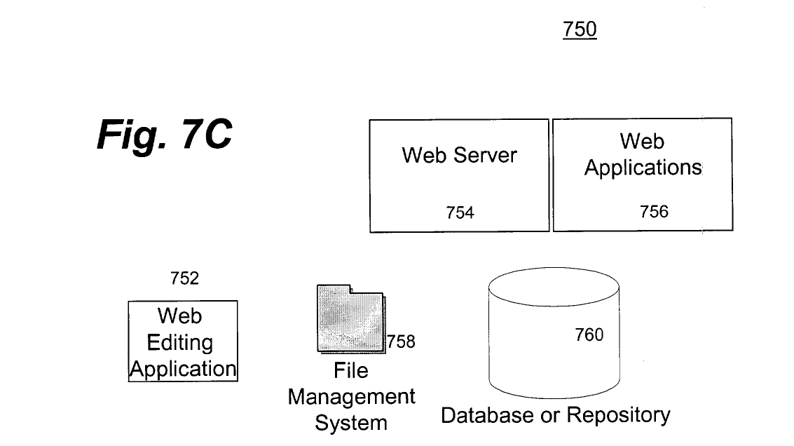

One type of the communications 610 of FIG. 6 pertains to the editing of one or more content objects. FIG. 7A shows a diagram involving objects, files and editors in editing one or more of the objects. In a particular application, an HTML page 700 is received for display in a web browser (e.g., Internet Browser). The HTML page 700 is a composition of two separate files, an XSL document 702 and an XML document 704. In other words, for each presentation of a content object, there are at least two files involved, one being the content source (e.g., the XML document 702) and the other being a style sheet (e.g., an XSL document 704), where the style-sheet enables the content source to be properly presented for a given application. In many applications, the style sheet is fixed while the contents are often updated.

When a machine hosts a number of content objects, a list of the objects 706 is provided such that a user accessing the machine can visually determine which related content object(s) are to be changed or updated. From the list 706, one of the objects to be changed can be selected. An editor 708 is provided to facilitate the editing of the selected objects. As shown in FIG. 7A, with the editor 708, the XML document 704 of an exemplary content object 710 can be readily updated and the HTML page 700 can reflect the change as soon as the change object is published. It should be noted that the description herein is for the content source, it is understood that the description is equally applied to the changes to style sheets if needed.

Similarly, if a user edits the HTML page 710 directly, appropriate changes will be reflected in the XML document 702 or/and XSL document 704 depending on what has been changed in the HTML page 710. FIG. 7B shows a configuration 720 in which the present invention may be practiced. An HTML Editor 722 is activated in a computer 724 to edit a specific HTML page 726. Associated with this HTML page 726 are an XSLT style sheet 728 and an XML document 730 or could be a collection of XML information obtained through various means. Both the XSLT style sheet 728 and the XML document 730 are included in one or more content objects, wherein the content objects can represent, in addition to one or more specific files and contents, APIs to another application that will provide specific information when called upon.

An application server 726 is configured to maintain the content objects and receives any updates to the content objects from other nodes. As a result, the HTML pages 724 can be potentially re-purposed for various devices, such as a PDA 732, a portable computer 734, or another language on another personal computer 736.

FIG. 7C shows an exemplary system 750 that can facilitate the web content or content objects to be edited over the Internet. The system 750 includes a web editing system 752 (e.g., on a server, not shown) is configured to works directly with a web server 754 that handles HTTP request and response messages over the Internet. Then a suite of web applications 756 that work directly with the web server 754 to handle the mechanism for managing the XML and XSL files for communicating with the web server 754 and the associated file management system 758 or database or other type of repository 760.

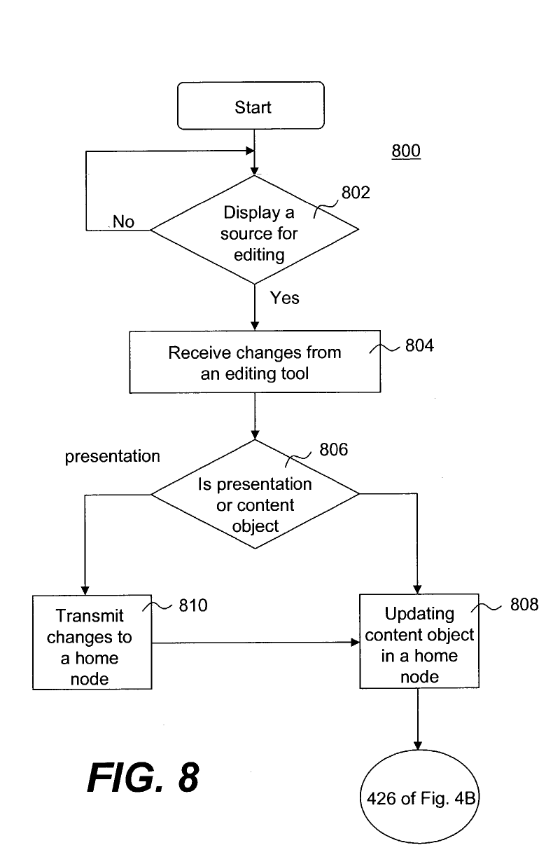

FIG. 8 shows a process or flowchart 800 of editing a web page or a content source. The process 800 may be used alone or in conjunction with the process 420 of FIG. 4B or the process 600 of FIG. 6. It is assumed that a user who attempts to edit a web page or a content object has been authenticated. As described above, the authorized user may edit a final presentation (e.g., an HTML page) or a content object (e.g., the content portion thereof), either one is referred to as a source.

At 802, the source is displayed, perhaps, in an editing user interface or tool. Depending on where the user is accessing, the source can be remotely located and retrieved for editing locally. The process 800 moves to 804 when the source is being edited. At 804, any changes to the source are received. For example, if the user edits an HTML page, the revised HTML file will be received. On the other hand, if the user edits a content object, the same content is received but with a changed content portion or presentation portion or both.

At 806, the process 800 determines what type of documents (a final presentation or a content object) has been changed. If the user has edited a content object, the process goes to 808 where a corresponding content is updated accordingly. If the user has edited a final presentation, the process 800 goes to 810 that cause the changes to be transmitted to a (home) node hosting the content object(s) used to represent the final presentation. Although not always necessary, the final presentation is on a remote device (e.g., the device 704 of FIG. 7B) thus the changed files need to be transmitted to a node configured to mange the content objects representing the final presentation. In any case, the process 800 goes to 808 where a corresponding content is updated accordingly. Once one of the content objects is changed, the process 800 can be introduced into the process 426 of the process 420 of FIG. 4B.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

There are numerous features, benefits and advantages in the present invention. One of them is a mechanism provided to ensure that information in a server is always updated by encapsulating the information in an object that may be managed in another machine. Another one of the features, benefits and advantages is that only authenticated user can access a computing machine to change/update an object. Still another one of the features, benefits and advantages is that an editing mechanism that enables an authorized user to edit the object directly or indirectly over a network. Other features, benefits and advantages can be readily appreciated by those skilled in the art from the foregoing description of the present invention.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for updating content objects over a network, the method comprising:
instantiating content objects, respectively, by software classes, each of the content objects encapsulating a content portion and a presentation portion;
executing a process including the software classes in a computing device to detect whether one or some of the content objects are changed; and
upon detecting one or some of the content objects being changed, starting an event to publish the one or some of the content objects that have been changed to one or more respective nodes that are associated with the one or some of the content objects.

2. The method of claim 1, wherein the content portion includes content in a markup language and the presentation portion is a style sheet facilitating the content to be presented properly in a given application.

3. The method of claim 2, wherein the markup language is XML and the style sheet is XSL.

4. The method of claim 2, wherein the content portion includes one or more XML files and the presentation portion includes one or more XSL files.

5. The method of claim 2, wherein a markup language file is generated from the content portion in accordance with the presentation portion.

6. The method of claim 2, wherein the markup language file is one of HTML file and the given application is a browser that, once executed, can display the HTML file.

7. The method of claim 1, wherein the process is performed to handle a full round-trip of updating in real-time the one or some of the content objects that have been changed, thus providing dynamic synchronization of the one or some of the content objects that have been changed.

8. The method of claim 7, wherein one or some of the content objects posses a link to other content objects, wherein the link is unidirectional.

9. The method of claim 8, wherein the computing device as a node communicate with the one or more respective nodes over a network.

10. The method of claim 8, further comprising:
requesting a ticket by a user from one of the respective nodes, wherein the ticket includes information on what the user claims to be;
receiving the ticket in an encrypted format;
decrypting the encrypted ticket with confidential information from the user; and
wherein the user is permitted to access one of the content objects in the one of the respective nodes, only after the encrypted ticket is successfully decrypted and returned for successful verification.

11. The method of claim 10, further comprising:
selecting one of the content objects from a list of the content objects;
editing the selected one of the content objects; and
saving the edited one of the content objects.

12. The method of claim 11, wherein the editing of the selected one of the content objects includes editing the content portion or editing the presentation portion.

13. The method of claim 10, further comprising:
displaying a page composed from the content portion and the presentation portion of an content object;
editing the displayed page; and
causing changes to the displayed page to update the content object.

14. A method for updating content objects over a network, the method comprising:
initiating an authentication procedure when a user attempts to change one or more content objects, each of the content objects encapsulating a content portion and a presentation portion, wherein each of the content objects is instantiated by a software class included in a process that is executed in a computing device;
permitting the user to change the one or more content objects after the authentication procedure is successful;
receiving changes to the one or more content objects; and
publishing the one or more content objects that have been changed to one or more respective nodes that are associated with the one or more content objects, upon detecting that the one or more content objects haven been changed.

15. The method of claim 14, wherein the initiating of the authentication procedure includes:
requesting a ticket by a user from one of the respective nodes, wherein the ticket includes information on what the user claims to be;
receiving the ticket in an encrypted format;
decrypting the encrypted ticket with confidential information from the user; and
wherein the user is permitted to access one of the content objects in the one of the respective nodes, only after the encrypted ticket is successfully decrypted and returned for successful verification.

16. The method of claim 15, wherein the receiving of the changes to the one or more content objects comprises:
selecting one of the content objects from a list of the content objects;
editing the selected one of the content objects; and
saving the edited one of the content objects.

17. The method of claim 16, wherein the editing of the selected one of the content objects includes editing the content portion or editing the presentation portion.

18. The method of claim 15, wherein the receiving of the changes to the one or more content objects comprises:
displaying a page composed from the content portion and the presentation portion of an content object;
editing the displayed page; and
causing the changes to the displayed page to update the content object.

19. A system for updating content objects over a network, the system comprising:
a hosting node including content objects, each of the content objects encapsulating a content portion and a presentation portion;
at least a supporting node configured to manage at least some of the content objects for the hosting node; and
wherein each of the at least some of the content objects is instantiated by a software class included in a process that is executed in the supporting node that publishes one or more content objects in the at least some of the content objects to the hosting node when the one or more content objects are detected to have been changed.

20. The system of claim 19, wherein each of the some of the content objects in the supporting node has a unidirectional link to a corresponding one of the content objects in the hosting node.

21. The system of claim 20, wherein a change to either one of the content objects in the hosting node or the supporting node causes a same change to a corresponding content object.

22. The system of claim 19, wherein the supporting node permits a user to change the one or more content objects after a successful authentication procedure including operations of:
issuing a ticket to the user, the ticket including information on what the user claims to be and sent in encrypted form;
receiving an decrypted ticket from the user, after the encrypted ticket is successfully decrypted with confidential information from the user; and
granting confidential access to the user to change the one or more content objects.

23. The system of claim 19, wherein each of the content objects further includes a transformation object and/or an API object; and wherein the transformation object permits specific operations on another content object before the another content object is sent and received by other calling applications and the API object facilitates a specific query to be either statically or dynamically generated.

24. The system of claim 23, wherein the API object is further used to provide specific information that is needed for calling applications that request the API object.
